(19) United States
(12) Patent Application Publication
(10) Pub. No.: US 2012/0096519 A1
(43) Pub. Date: Apr. 19, 2012

(54) Methods and Apparatuses for Avoiding Denial of Service Attacks By Rogue Access Points

(75) Inventors: Seppo Matias Alanara, Oulu (FI); Antti-Eemeli Suronen, Oulu (FI); Henri Markus Koskinen, Espoo (FI)

(73) Assignee: NOKIA CORPORATION, Espoo (FI)

(21) Appl. No.: 13/378,247

(22) PCT Filed: Jun. 24, 2009
(86) PCT No.: PCT/IB09/52723

§ 371 Date: Dec. 14, 2011

(51) Int. Cl. H04W 12/12; H04W 12/08; H04L 29/06

(52) U.S. Cl. 726/3

(57) ABSTRACT

Methods and apparatuses are provided for avoiding denial of service attacks by rogue access points. A method may include attempting to verify activation of access stratum security by an access point based at least in part upon integrity protection information included in a received security mode command message sent by the access point, wherein a radio connection has been established with the access point. The method may further include detecting an occurrence of a security activation deadlock. The method may additionally include determining that a predefined number of security activation deadlocks with the access point have occurred. The method may also include identifying the access point as a rogue access point based at least in part upon the determination that a predefined number of security activation deadlocks with the access point have occurred. Corresponding apparatuses are also provided.

### TECHNOLOGICAL FIELD

Embodiments of the present invention relate generally to communication technology and, more particularly, relate to methods and apparatuses for avoiding denial of service attacks by rogue access points.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer and providing convenience to users. In parallel with the expansion of networks, mobile computing devices have been developed that take advantage of features offered by wireless networks to facilitate mobile computing. As a result, mobile communication devices and wireless networks are widely used by consumers to support mobile computing use for both personal and business purposes.

However, as wireless communication has become a more integral part of the everyday personal and professional lives of consumers, malicious parties sometimes attempt to disrupt mobile communication service. In this regard a malicious party may effect a denial of service attack on a mobile communication device through the use of a rogue base station configured to attempt to maintain a connection with the mobile communication device while not providing full network service to the device.

### BRIEF SUMMARY OF SOME EXAMPLES OF THE INVENTION

Methods, apparatuses, and computer program products are therefore provided for avoiding denial of service attacks by rogue access points. In this regard, methods, apparatuses, and computer program products are provided that may provide several advantages to computing devices, computing device users, and network operators. Embodiments of the invention provide terminals configured to determine an occurrence of a security activation deadlock following failure of an attempt to verify activation of access stratum security by an access point. Embodiments of the invention further provide terminals configured to identify an access point as a rogue access point following occurrence of a predefined number of security activation deadlocks with the access point such that the terminal may autonomously release a radio connection with the base station and select another access point. Some embodiments of the invention provide for a blacklist to which access points are added following occurrence of a predefined number of security activation deadlocks, such that a terminal will not attempt a future connection with an access point on the blacklist. Accordingly, embodiments of the invention mitigate denial of service attacks by rogue access points.

In a first example embodiment, a method is provided, which comprises attempting to verify activation of access stratum security by an access point based at least in part upon integrity protection information included in a received security mode command message sent by the access point, wherein a radio connection has been established with the access point. The method of this embodiment further comprises detecting an occurrence of a security activation deadlock. The method of this embodiment additionally comprises determining that a predefined number of security activation deadlocks with the access point have occurred. The method of this embodiment also comprises identifying the access point as a rogue base station based at least in part upon the determination that the predefined number of security activation deadlocks with the access point have occurred.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least attempt to verify activation of access stratum security by an access point based at least in part upon integrity protection information included in a received security mode command message sent by the access point, wherein a radio connection has been established with the access point. The at least one memory and stored computer program code are configured to, with the at least one processor, further cause the apparatus of this embodiment to detect an occurrence of a security activation deadlock. The at least one memory and stored computer program code are configured to, with the at least one processor, additionally cause the apparatus of this embodiment to determine that a predefined number of security activation deadlocks with the access point have occurred. The at least one memory and stored computer program code are configured to, with the at least one processor, also cause the apparatus of this embodiment to identify the access point as a rogue access point based at least in part upon the determination that the predefined number of security activation deadlocks with the access point have occurred.

In another example embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is configured for attempting to verify activation of access stratum security by an access point based at least in part upon integrity protection information included in a received security mode command message sent by the access point, wherein a radio connection has been established with the access point. The second program instruction of this embodiment is configured for detecting an occurrence of a security activation deadlock. The third program instruction of this embodiment is configured for determining that a predefined number of security activation deadlocks with the access point have occurred. The fourth program instruction of this embodiment is configured for identifying the access point as a rogue access point based at least in part upon the determination that the predefined number of security activation deadlocks with the access point have occurred.

In another example embodiment, an apparatus is provided that comprises means for attempting to verify activation of access stratum security by an access point based at least in part upon integrity protection information included in a received security mode command message sent by the access point, wherein a radio connection has been established with the access point. The apparatus of this embodiment further comprises means for detecting an occurrence of a security activation deadlock. The apparatus of this embodiment additionally comprises means for determining that a predefined number of security activation deadlocks with the access point have occurred. The apparatus of this embodiment also comprises means for identifying the access point as a rogue access point based at least in part upon the determination that the predefined number of security activation deadlocks with the access point have occurred.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for avoiding denial of service attacks by rogue access points according to an exemplary embodiment of the present invention;

FIG. 2 is a schematic block diagram of a mobile terminal according to an exemplary embodiment of the present invention;

FIG. 3 illustrates a signaling diagram of signals that may be exchanged between a terminal and access point according to an exemplary method for avoiding denial of service attacks by rogue access points according to an exemplary embodiment of the present invention;

FIG. 4 illustrates a flowchart according to an exemplary method for avoiding denial of service attacks by rogue access points according to an exemplary embodiment of the invention;

FIG. 5 illustrates a flowchart according to an exemplary method for avoiding denial of service attacks by rogue access points according to an exemplary embodiment of the invention;

FIG. 6 illustrates a flowchart according to an exemplary method for avoiding denial of service attacks by rogue access points according to an exemplary embodiment of the invention; and

FIG. 7 illustrates a flowchart according to an exemplary method for maintaining a whitelist of trusted access points for avoiding denial of service attacks by rogue access points according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

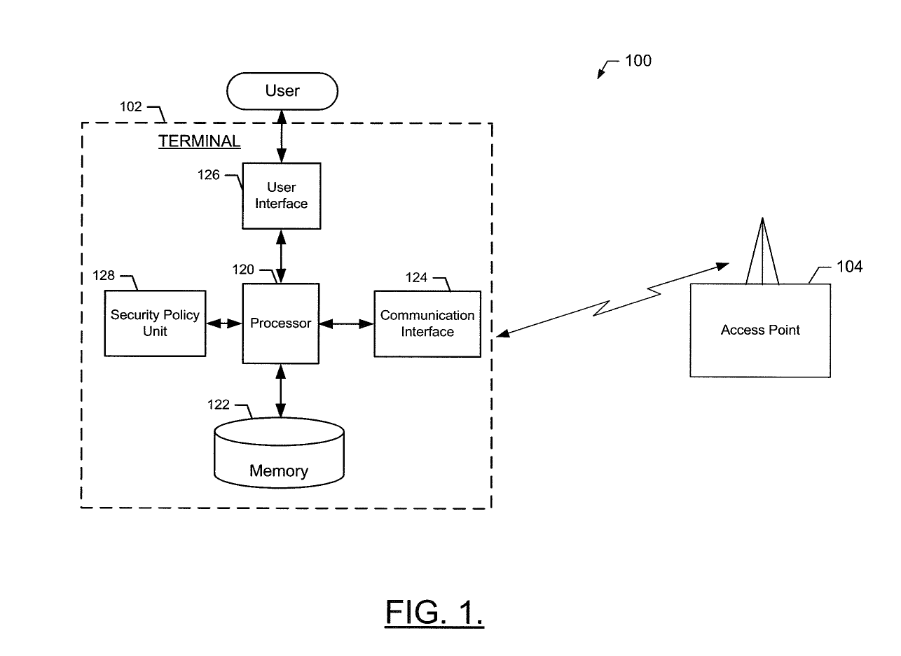

FIG. 1 illustrates a block diagram of a system 100 for avoiding denial of service attacks by rogue access points according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for avoiding denial of service attacks by rogue access points, numerous other configurations may also be used to implement embodiments of the present invention.

Where reference is made herein to a particular networking technology, such as Long Term Evolution (LTE) or Evolved Universal Terrestrial Radio Access Network (E-UTRAN) in accordance with Third Generation Partnership Project (3GPP) standards, it will be appreciated that the reference to the particular networking technology is merely for purposes of example in accordance with one embodiment of the invention and that embodiments of the invention may be applied to other networking technologies. Similarly, where reference is made to terminology for an apparatus, component, message, signal, protocol, and/or the like in accordance with terminology used in a particular networking technology, it will be appreciated that the reference is for purposes of example and not by way of limitation to a particular networking technology.

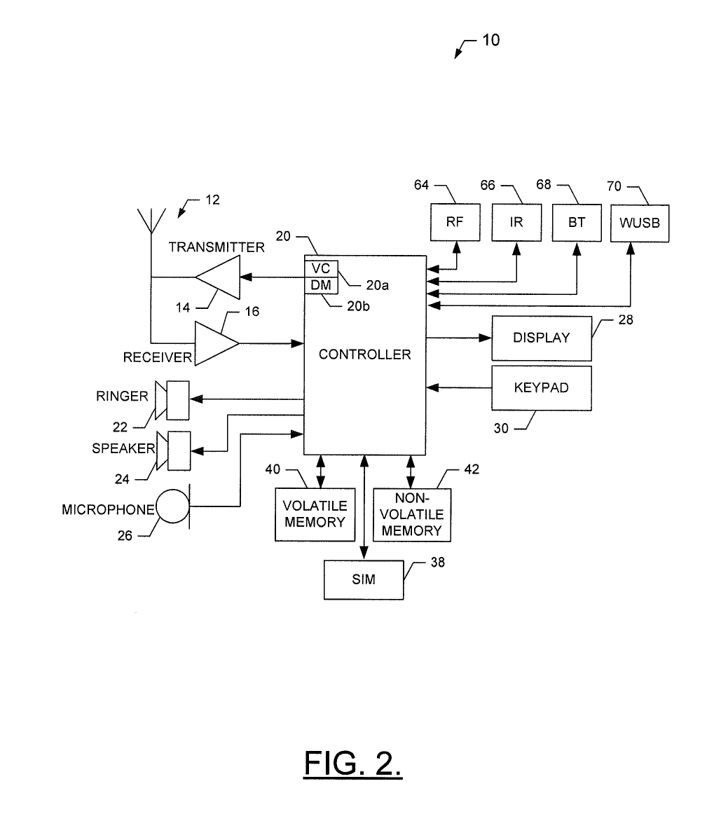

In at least some embodiments, the system 100 includes one or more terminals 102 and one or more access points 104. The access point 104 may comprise a base station, node B, evolved node B, and/or other network access point configured to establish a radio connection with a terminal 102. The access point 104 may additionally comprise and/or may be in communication with components of a network cell, such as, for example, an E-UTRAN. The terminal 102 may be embodied as a desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like configured to establish a radio connection with an access point 104. In an exemplary embodiment, the terminal 102 is embodied as a mobile terminal, such as that illustrated in FIG. 2.

In this regard, FIG. 2 illustrates a block diagram of a mobile terminal 10 representative of one embodiment of a terminal 102 in accordance with embodiments of the present invention. It should be understood, however, that the mobile terminal 10 illustrated and hereinafter described is merely illustrative of one type of terminal 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. In this regard, the controller 20 may comprise user interface circuitry configured to control at least some functions of one or elements of the user interface, such as, for example, the speaker 24, the ringer 22, the microphone 26, the display 28, and/or the like. The controller 20 and/or user interface circuitry comprising the controller 20 may be configured to control one or more functions of one or more elements of the user interface through computer program instructions (for example, software and/or firmware) stored on a memory accessible to the controller 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning now to FIG. 1, in an exemplary embodiment the terminal 102 includes various means, such as a processor 120, memory 122, communication interface 124, user interface 126, and security policy unit 128 for performing the various functions herein described. These means of terminal 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 122) that is executable by a suitably configured processing device (for example, the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be in operative communication with each other and may be collectively configured to perform one or more functionalities of the terminal 102 as described herein. In embodiments wherein the terminal 102 is embodied as a mobile terminal 10, the processor 120 may be embodied as or comprise the controller 20. In an exemplary embodiment, the processor 120 is configured to execute instructions stored in the memory 122 or otherwise accessible to the processor 120. These instructions, when executed by the processor 120, may cause the terminal 102 to perform one or more of the functionalities of the terminal 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. Although illustrated in FIG. 1 as a single memory, the memory 122 may comprise a plurality of memories. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the terminal 102 is embodied as a mobile terminal 10, the memory 122 may comprise the volatile memory 40 and/or the non-volatile memory 42. The memory 122 may be configured to store information, data, applications, instructions, or the like for enabling the terminal 102 to carry out various functions in accordance with exemplary embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the security policy unit 128 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example., the processor 120), or a combination thereof that is configured to receive and/or transmit data from/to an entity of the system 100, such as, for example, an access point 104. In this regard, the communication interface 124 may be configured to establish a radio connection with an access point 104. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more entities of the system 100. The communication interface 124 may be configured to receive and/or transmit data using any protocol that may be used for communications between entities of the system 100. The communication interface 124 may additionally be in communication with the memory 122, user interface 126, and/or security policy unit 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. The user interface 126 may be in communication with the memory 122, communication interface 124, and/or security policy unit 128, such as via a bus.

The security policy unit 128 may be embodied as various means, such as circuitry, hardware, a computer program product comprising computer readable program instructions stored on a computer readable medium (for example., the memory 122) and executed by a processing device (for example, the processor 120), or some combination thereof and, in one embodiment, is embodied as or otherwise controlled by the processor 120. In embodiments wherein the security policy unit 128 is embodied separately from the processor 120, the security policy unit 128 may be in communication with the processor 120. The security policy unit 128 may further be in communication with one or more of the memory 122, communication interface 124, or user interface 126, such as via a bus.

The communication interface 124 may be configured to establish a radio connection, such as, for example, a radio resource control (RRC) connection, with the access point 104. Establishment of this radio connection may be in accordance with any network standard or protocol which the terminal 102 and/or access point 104 are configured to implement. In one embodiment, the communication interface 124 is configured to establish a radio connection (for example, an RRC connection) with the access point 104 in accordance with LTE standards.

The security policy unit 128 may be configured to select an access point 104 to establish a radio connection, such as, for example, an RRC connection, with. Following establishment of the radio connection, the access point 104 may transmit a security mode command (SMC) message to the terminal 102, where it may be received by the communication interface 124. It will be appreciated that “SMC message” is used by way of example and not by way of limitation with respect to any one networking standard and thus where SMC messages are referred to herein, similar messages transmitted in accordance with other networking standards are within the scope of SMC message as used herein. The SMC message may include integrity protection information for use by the terminal 102 to verify activation of access stratum security by the access point 104. The integrity protection information may, for example, comprise a Message Authentication Code (MAC) and/or other integrity protection information for use by the security policy unit 128 to verify the integrity protection of the SMC message and to verify activation of access stratum security measures by the access point 104. The access stratum security measures may include, for example, integrity protection and ciphering for use in communications between the terminal 102 and access point 104.

The security policy unit 128 may be configured to extract the integrity protection information from an SMC message received by the terminal 102 and attempt to verify the integrity protection information so as to verify activation of access stratum security by the access point 104. When security activation fails (for example, when the security policy unit 128 cannot verify the integrity protection information), the security policy unit 128 may be configured to cause the communication interface 124 to transmit a security mode failure message to the access point 104. It will be appreciated that “security mode failure message” is used by way of example and not by way of limitation with respect to any one networking standard and thus where security mode failure messages are referred to herein, similar messages transmitted in accordance with other networking standards are within the scope of security mode failure message as used herein.

In accordance with various networking standards, such as LTE standards, the access point 104 may be specified to release the radio connection with the terminal 102 following receipt of the security mode failure message. However, a rogue access point 104 configured for launching a denial of service attack on a terminal 102 may not release the radio connection. Additionally or alternatively, a rogue access point 104 may transmit an SMC message including invalid integrity protection information to the terminal 102 each time a terminal 102 establishes a radio connection with the access point 104. Accordingly, embodiments of the invention provide solutions to mitigate such denial of service attacks by a rogue access point 104.

When the security policy unit 128 fails to verify activation of access stratum security by the access point 104, the security policy unit 128 is configured in some embodiments of the invention to detect an occurrence of a security activation deadlock so as to mitigate the effects of a potential denial of service attack. In this regard, the security policy unit 128 may be configured to detect a security activation deadlock occurrence when waiting for the access point 104 to release the radio connection following transmission of a security mode failure message to the access point 104. In order to detect the security activation deadlock, the security policy unit 128 may be configured to set a deadlock timer in response to transmission of the security mode failure message to the access point 104. Setting the deadlock timer in response to the transmission may comprise setting the deadlock timer concurrent with transmission of the security mode failure message, following transmission of the security mode failure message, upon receipt of an acknowledgement transmitted by the access point 104 acknowledging receipt of the security mode failure message, and/or the like. The deadlock timer may be set to run for a predefined period of time (for example, a deadlock period), after which the deadlock timer will expire. The security policy unit 128 may be configured to detect that a security activation deadlock has occurred when the access point 104 has not released the radio connection with the terminal 102 upon expiration of the deadlock timer.

When the security policy unit 128 detects an occurrence of a security activation deadlock, the security policy unit 128 may be configured to adjust a counter value associated with the identity of the access point 104 that indicates the number of security activation deadlocks with the access point that have occurred. For example, the counter value may store the number of security activation deadlocks that have occurred with the access point and the security policy unit 128 may be configured to increment the counter value in response to detecting an occurrence of a security activation deadlock with the access point. In another example, the counter value may store a value equal to the difference between a predefined number and the number of security activation deadlocks with the access point that have occurred and the security policy unit 128 may be configured to decrement the counter value in response to detecting an occurrence of a security activation deadlock with the access point. It will be appreciated that these examples are provided merely for purposes of example and not by way of limitation and the security policy unit 128 may be configured to adjust the counter value in other ways and the counter value may indicate the number of security activation deadlocks that have occurred with the access point in other ways. The counter value may be stored in the memory 122. If there is not a preexisting counter value associated with the access point 104, the security policy unit 128 may be configured to generate a new counter value and set the value appropriately (for example, set the value to 1 to denote the occurrence of one security activation deadlock with the access point 104). The counter value(s) stored in memory 122 may be purged and/or reset in accordance with a policy that the security policy unit 128 is configured to impose to ensure freshness of the counter value(s). For example, the security policy unit 128 may be configured to reset the counter value(s) periodically, upon repowering of the terminal 102, a predefined amount of time following the last security activation deadlock recorded for the counter value(s), and/or other policy.

The security policy unit 128 is further configured in some embodiments of the invention to determine that a predefined number of security activation deadlocks with the access point 104 have occurred. In this regard, the security policy unit 128 may be configured to determine whether the counter value for the access point 104 has a predetermined relationship to a predefined number to determine whether a predefined number of security activation deadlocks with the access point 104 have occurred. For example, if the counter value stores a number of security activation deadlocks that have occurred and is incremented by the security policy unit 128 upon an occurrence of a security activation deadlock, the security policy unit 128 may be configured to determine whether the counter value equals the predefined number. In another example, if the security policy unit 128 sets the counter value to an initial value of the predefined number and decrements the counter value upon an occurrence of a security activation deadlock, the security policy unit 128 may be configured to determine whether the counter value equals zero. It will be appreciated, however, that these examples are provided merely as examples and not by way of limitation and the security policy unit 128 may be configured to set the counter value to other initial values, adjust the counter value in other ways upon an occurrence of a security activation deadlock, and determine whether the counter value has other predetermined relationships to the predefined number. If the security policy unit 128 determines that the predefined number of security activation deadlocks have occurred, the security policy unit 128 may be configured to identify the access point as a rogue access point based at least in part upon the determination. The security policy unit 128 may be configured to cause the communication interface 124 to autonomously release the radio connection with a rogue access point and to prevent future establishment of a radio connection with an access point 104 identified as a rogue access point.

In some embodiments, the security policy unit 128 is configured to maintain a blacklist of access points 104 identified as rogue access points. The security policy unit 128 may be configured to store the blacklist in the memory 122. When selecting an access point to connect to (for example, based on measurement reports or other criteria), the security policy unit 128 may be configured to not select an access point(s) 104 on the blacklist when selecting an access point 104 to connect to. The security policy unit 128 may be configured to purge the blacklist and/or remove an access point 104 from the blacklist in accordance with a policy that the security policy unit 128 is configured to impose. For example, the security policy unit 128 may be configured to purge the blacklist upon repowering of the terminal 102. In another example, the security policy unit 128 may be configured to remove an access point 104 from the blacklist after a predefined amount of time has elapsed since the access point 104 was added to the blacklist.

When the security policy unit 128 identifies an access point 104 as a rogue access point, the security policy unit 128 may be further configured to disregard any list of neighboring access points 104 provided to the terminal 102 by the rogue access point 104 when selecting a new access point 104 to establish a connection with. In this regard, the security policy unit 128 may mitigate any attempt by a rogue access point 104 to deny service to the terminal 102 by encouraging the terminal 102 to select another rogue access point to connect to.

In some embodiments, the security policy unit 128 is further configured to maintain a whitelist, such as may be stored in memory 122, of trusted access points 104. The security policy unit 128 may add an access point 104 to the whitelist when the security policy unit 128 has successfully verified activation of access stratum security by the access point 104 (for example, the integrity protection information included in the received SMC message is verified to be valid). The security policy unit 128 may be configured to purge the whitelist and/or remove an access point 104 from the whitelist in accordance with a policy that the security policy unit 128 is configured to impose. For example, the security policy unit 128 may be configured to purge the whitelist upon repowering of the terminal 102. In another example, the security policy unit 128 may be configured to remove an access point 104 from the whitelist after a predefined amount of time has elapsed since the access point 104 was added to the whitelist. In a further example, the security policy unit 128 may be configured to remove an access point 104 from the whitelist if the security policy unit 128 later identifies the access point 104 as a rogue access point. The security policy unit 128 may be configured to not add an access point 104 to the blacklist even if a predefined number of security activation deadlocks have occurred with the access point 104 if the access point 104 is on the whitelist.

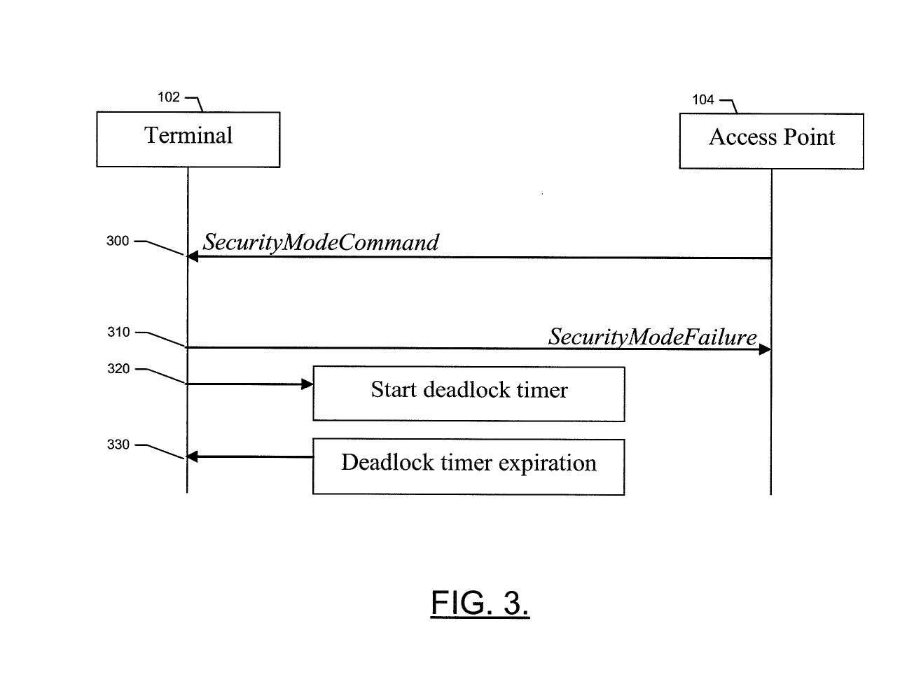

FIG. 3 illustrates a signaling diagram of signals that may be exchanged between a terminal 102 and access point 104 according to an exemplary method for avoiding denial of service attacks by rogue access points according to an exemplary embodiment of the present invention. At operation 300, the communication interface 124 may receive an SMC message transmitted by the access point 104. The security policy unit 128 may then attempt to verify activation of access stratum security by the access point 104 based at least in part upon integrity protection information included in the SMC message. When the security policy unit 128 fails to verify activation of access stratum security, the security policy unit 128 may be configured to transmit a security mode failure message to the access point 104, at operation 310. Operation 320 may comprise the security policy unit 128 starting a deadlock timer. The security policy unit 128 may then determine that a security activation deadlock has occurred at operation 330 upon expiration of the deadlock timer.

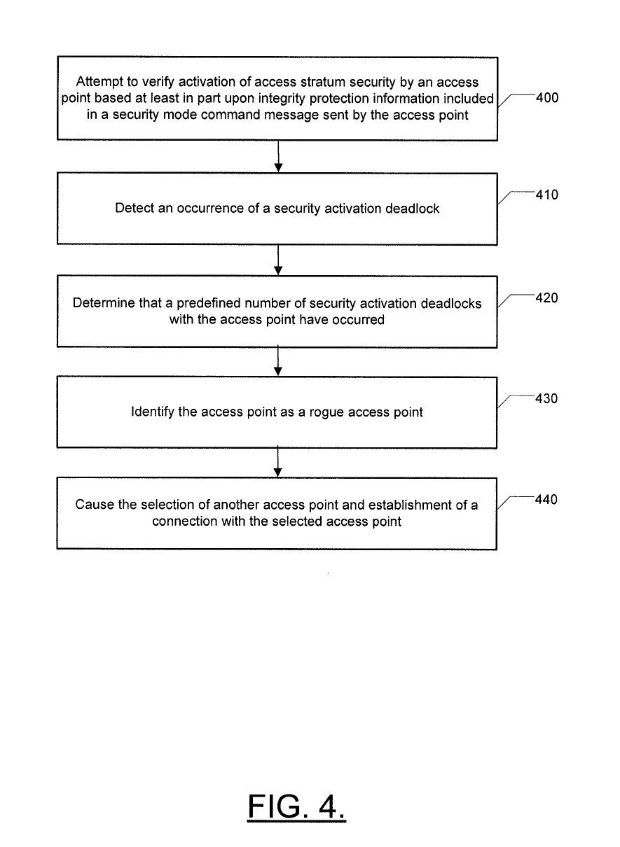

FIG. 4 illustrates a flowchart according to an exemplary method for avoiding denial of service attacks by rogue access points according to an exemplary embodiment of the invention. In this regard, FIG. 4 illustrates operations that may be performed by the security policy unit 128. The method may include the security policy unit 128 attempting to verify activation of access stratum security by an access point 104 with which a radio connection has been established, at operation 400. Operation 410 may comprise the security policy unit 128 detecting an occurrence of a security activation deadlock. The security policy unit 128 may then determine that a predefined number of security activation deadlocks with the access point 104 have occurred, at operation 420. Operation 430 may comprise the security policy unit 128 identifying the access point 104 as a rogue access point. The security policy unit 128 may then cause the communication interface 124 to autonomously release the radio connection with the access point 104 and may then cause the selection of another access point 104 and establishment of a connection with the selected access point 104, at operation 440. It will be appreciated, however, that embodiments of the invention are not limited to the ordering of steps illustrated in FIG. 4 and described above. Thus, for example, the security policy unit 128 may be configured to cause the release of the radio connection with the access point 104 at any point after the detection of an occurrence of a security activation deadlock (for example, before operation 420 and/or before operation 430).

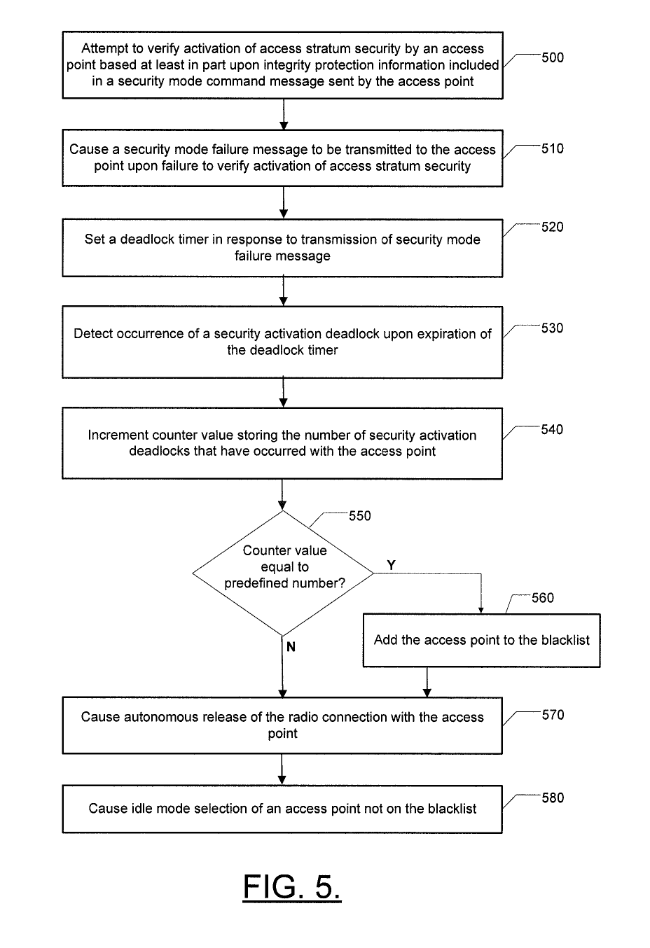

FIG. 5 illustrates a flowchart according to an exemplary method for avoiding denial of service attacks by rogue access points according to an exemplary embodiment of the invention. In this regard, FIG. 5 illustrates operations that may be performed by the security policy unit 128. Operation 500 may comprise the security policy unit 128 attempting to verify activation of access stratum security by an access point 104 with which a radio connection has been established. The security policy unit 128 may then cause a security mode failure message to be transmitted to the access point 104 upon failure to verify activation of access stratum security, at operation 510. Operation 520 may comprise the security policy unit 128 setting a deadlock timer in response to transmission of the security mode failure message. The security policy unit 128 may then detect occurrence of a security activation deadlock upon expiration of the deadlock timer (for example., if the access point 104 has not released the radio connection upon expiration of the deadlock timer), at operation 530. Operation 540 may comprise the security policy unit 128 incrementing a counter value indicating the number of security activation deadlocks that have occurred with the access point 104. The security policy unit 128 may then determine whether the counter value is equal to the predefined number, at operation 550. When the security policy unit 128 determines that the counter value is equal to the predefined number, the security policy unit 128 may add the access point 104 to the blacklist, at operation 560. It will be appreciated that operations 540-560 are provided merely by way of example and not by way of limitation, and incrementation is one example of how the security policy unit 128 may be configured to adjust a counter value in response to determining an occurrence of a security activation deadlocks. In other embodiments, for example, the security policy unit 128 may initially set the counter value to the predefined number and decrement the counter value upon each occurrence of a security activation deadlock until the counter reaches zero, when the security policy unit 128 may add the access point to the blacklist. Operation 570 may comprise the security policy unit 128 causing the autonomous release of the radio connection with the access point 104. The security policy unit 128 may then cause idle mode selection of an access point 104 not on the blacklist, such as in accordance with selection policy implemented on the terminal 102 (for example., based at least in part upon measurement reports) at operation 580. The selected access point 104 may comprise the same access point 104 with which the radio connection was just released if the access point 104 is not on the blacklist. It will be appreciated, however, that embodiments of the invention are not limited to the ordering of steps illustrated in FIG. 5 and described above. For example, the security policy unit 128 may be configured to cause the release of the radio connection with the access point 104 at any point after the detection of an occurrence of a security activation deadlock. Thus, operation 570 may occur at any point following operation 640 and is not limited to occurring following operation 550.

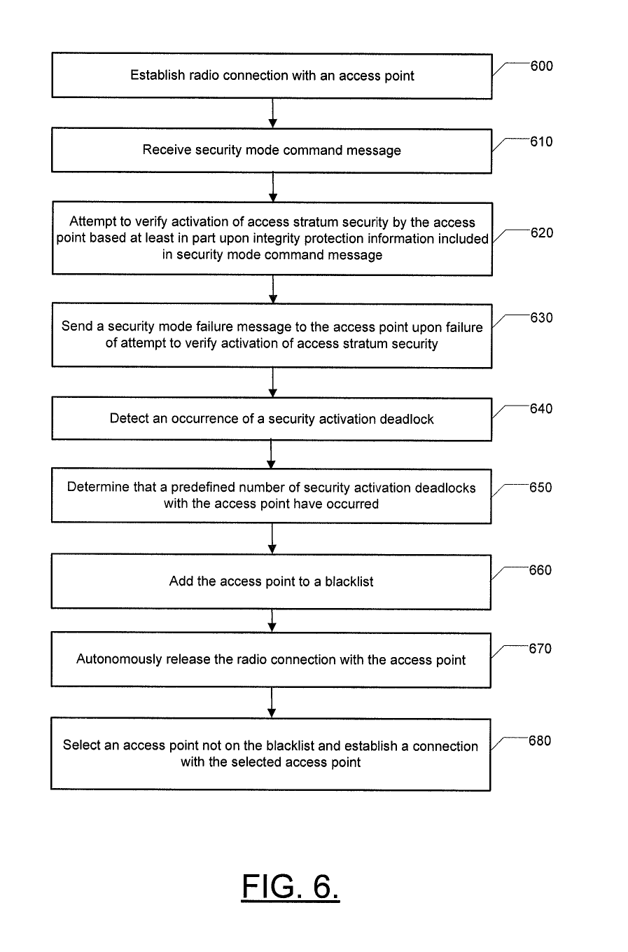

FIG. 6 illustrates a flowchart according to an exemplary method for avoiding denial of service attacks by rogue access points according to an exemplary embodiment of the invention. In this regard, FIG. 6 illustrates operations that may be performed by the terminal 102. Operation 600 may comprise the terminal 102 establishing a radio connection (for example, a RRC connection) with an access point 104. The terminal 102 may then receive a security mode command message transmitted by the access point 104, at operation 610. Operation 620 may comprise the terminal 102 attempting to verify activation of access stratum security by the access point 104 based at least in part upon integrity protection information included in the SMC message. The terminal 102 may then send a security mode failure message to the access point 104 upon failure of the attempt to verify activation of access stratum security, at operation 630. Operation 640 may comprise the terminal 102 detecting an occurrence of a security activation deadlock. The terminal 102 may then determine that a predefined number of security activation deadlocks with the access point 104 have occurred, at operation 650. Operation 660 may comprise the terminal 102 adding the access point 104 to a blacklist. The terminal 102 may then autonomously release the radio connection with the access point 104, at operation 670. Operation 680 may comprise the terminal 102 selecting an access point not on the blacklist and establishing a connection with the selected access point. It will be appreciated, however, that embodiments of the invention are not limited to the ordering of steps illustrated in FIG. 6 and described above. For example, the terminal 102 may be configured to autonomously release the radio connection with the access point 104 at any point after the detection of an occurrence of a security activation deadlock. Thus, operation 670 may occur at any point following operation 640 and is not limited to occurring following operation 660.

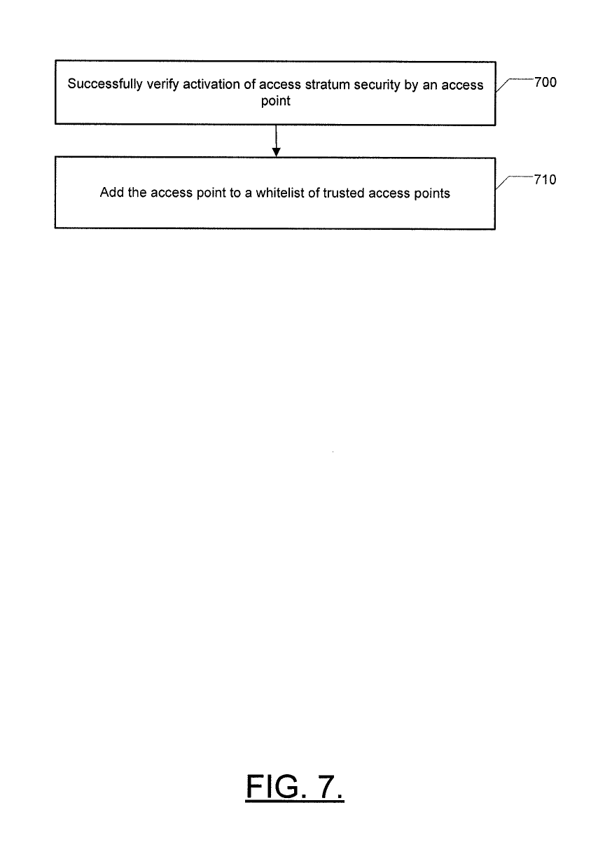

FIG. 7 illustrates a flowchart according to an exemplary method for maintaining a whitelist of trusted access points for avoiding denial of service attacks by rogue access points according to an exemplary embodiment of the invention. Operation 700 may comprise the security policy unit 128 successfully verifying activation of access stratum security by an access point 104. The security policy unit 128 may then add the access point 104 to a whitelist of trusted access points, at operation 710.

FIGS. 4-7 are flowcharts of a system, method, and computer program product according to exemplary embodiments of the invention. It will be understood that each block or step of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices, computing device users, and network operators. Embodiments of the invention provide terminals configured to determine an occurrence of a security activation deadlock following a failure to verify activation of access stratum security by an access point. Embodiments of the invention further provide terminals configured to identify an access point as a rogue access point following occurrence of a predefined number of security activation deadlocks with the access point such that the terminal may autonomously release a radio connection with the access point and select another access point. Some embodiments of the invention provide for a blacklist to which access points are added following occurrence of a predefined number of security activation deadlocks, such that a terminal will not attempt a future connection with an access point on the blacklist. Accordingly, embodiments of the invention mitigate denial of service attacks by rogue access points.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-20. (canceled)

21. A method comprising:
attempting to verify activation of access stratum security by an access point based at least in part upon integrity protection information included in a received security mode command message sent by the access point, wherein a radio connection has been established with the access point;
detecting an occurrence of a security activation deadlock;
determining that a predefined number of security activation deadlocks with the access point have occurred; and
identifying the access point as a rogue access point based at least in part upon the determination that the predefined number of security activation deadlocks with the access point have occurred.

22. The method of claim 21, wherein identifying the access point as a rogue access point further comprises adding the access point to a blacklist such that future connections to the access point will not be attempted while the access point is on the blacklist.

23. The method of claim 21, wherein detecting the occurrence of the security activation deadlock further comprises detecting that a deadlock has occurred while waiting for the access point to release the radio connection following transmission of a security mode failure message to the access point.

24. The method of claim 23, wherein detecting the occurrence of the security activation deadlock further comprises:
setting a deadlock timer in response to transmission of the security mode failure message to the access point; and
detecting that a security activation deadlock has occurred when the access point has not released the radio connection upon expiration of the deadlock timer.

25. The method of claim 23, further comprising adjusting a counter value indicating a number of security activation deadlocks with the access point that have occurred following detection of the security activation deadlock; and
wherein determining that a predefined number of security activation deadlocks with the access point have occurred further comprises determining the counter value has a predetermined relationship to the predefined number.

26. The method of claim 21, further comprising causing establishment of a radio connection with a different access point following identification of the access point as a rogue access point.

27. The method of claim 21, further comprising maintaining a whitelist of access points which have previously been verified to have activated access stratum security, wherein access points on the whitelist are accorded preference when selecting an access point.

28. An apparatus comprising at least one processor and at least one memory storing computer program code, wherein the at least one memory and stored computer program code are configured to, with the at least one processor, cause the apparatus to at least:
attempt to verify activation of access stratum security by an access point based at least in part upon integrity protection information included in a received security mode command message sent by the access point, wherein a radio connection has been established with the access point;
detect an occurrence of a security activation deadlock;
determine that a predefined number of security activation deadlocks with the access point have occurred; and
identify the access point as a rogue access point based at least in part upon the determination that a predefined number of security activation deadlocks with the access point have occurred.

29. The apparatus of claim 28, wherein the at least one memory and stored computer program code are further configured to, with the at least one processor, cause the apparatus to identify the access point as a rogue access point by adding the access point to a blacklist such that future connections to the access point will not be attempted while the access point is on the blacklist.

30. The apparatus of claim 28, wherein the at least one memory and stored computer program code are further configured to, with the at least one processor, cause the apparatus to detect the occurrence of the security activation deadlock by detecting that a deadlock has occurred while waiting for the access point to release the radio connection following transmission of a security mode failure message to the access point.

31. The apparatus of claim 30, wherein the at least one memory and stored computer program code are further configured to, with the at least one processor, cause the apparatus to detect the occurrence of a security activation deadlock by:
setting a deadlock timer in response to transmission of the security mode failure message to the access point; and
detecting that a security activation deadlock has occurred when the access point has not released the radio connection upon expiration of the deadlock timer.

32. The apparatus of claim 30, wherein the at least one memory and stored computer program code are further configured to, with the at least one processor, further cause the apparatus to adjust a counter value indicating a number of security activation deadlocks with the access point that have occurred following detection of the security activation deadlock; and
wherein the at least one memory and stored computer program code are configured to, with the at least one processor, cause the apparatus to determine that a predefined number of security activation deadlocks with the access point have occurred by determining the counter value has a predefined relationship to the predefined number.

33. The apparatus of claim 28, wherein the at least one memory and stored computer program code are further configured to, with the at least one processor, further cause the apparatus to establish a radio connection with a different access point following identification of the access point as a rogue access point.

34. The apparatus of claim 28, wherein the at least one memory and stored computer program code are further configured to, with the at least one processor, further cause the apparatus to maintain a whitelist of access points which have previously been verified to have activated access stratum security, wherein access points on the whitelist are accorded preference when selecting an access point.

35. The apparatus of claim 28, wherein the apparatus comprises or is embodied on a mobile phone, the mobile phone comprising user interface circuitry and user interface software stored on one or more of the at least one memory; wherein the user interface circuitry and user interface software are further configured to:
facilitate user control of at least some functions of the mobile phone through use of a display; and
cause at least a portion of a user interface of the mobile phone to be displayed on the display to facilitate user control of at least some functions of the mobile phone.

36. A computer program product comprising at least one computer-readable storage medium having computer-readable program instructions stored therein, the computer-readable program instructions comprising:
a program instruction configured for attempting to verify activation of access stratum security by an access point based at least in part upon integrity protection information included in a received security mode command message sent by the access point, wherein a radio connection has been established with the access point;
a program instruction configured for detecting an occurrence of a security activation deadlock;
a program instruction configured for determining that a predefined number of security activation deadlocks with the access point have occurred; and
a program instruction configured for identifying the access point as a rogue access point based at least in part upon the determination that a predefined number of security activation deadlocks with the access point have occurred.

37. The computer program product of claim 36, wherein the program instruction configured for identifying the access point as a rogue access point further comprises instructions configured for addling the access point to a blacklist such that future connections to the access point will not be attempted while the access point is on the blacklist.

38. The computer program product of claim 36, wherein the program instruction configured for detecting the occurrence of the security activation deadlock further comprises instructions configured for detecting that a deadlock has occurred while waiting for the access point to release the radio connection following transmission of a security mode failure message to the access point.

39. The computer program product of claim 36, further comprising a program instruction configured for causing establishment of a radio connection with a different access point following identification of the access point as a rogue access point.

40. The computer program product of claim 36, further comprising a program instruction configured for maintaining a whitelist of access points which have previously been verified to have activated access stratum security, wherein access points on the whitelist are accorded preference when selecting an access point.
